(19) United States
(12) Patent Application Publication
(10) Pub. No.: US 2009/0171809 A1
(43) Pub. Date: Jul. 2, 2009

(54) EFFICIENT PURCHASE ORDER CREATION

(76) Inventor: Martina Rothley, Schwetzingen (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/965,468

(22) Filed: Dec. 27, 2007

(51) Int. Cl. G06Q 30/00; G06F 3/048

(52) U.S. Cl. 705/27; 715/764

(57) ABSTRACT

A system may include detection of a user selection of a purchasing-related document and, in response to the detection, automatic creation of a new purchase order based on the selected document. At least one data element of the new purchase order is identical to a data element of the selected document.

### FIELD

Some embodiments relate to the creation of purchase orders. In particular, some embodiments concern automatic creation of purchase orders based on an existing document.

### BACKGROUND

Purchase orders present a formalized mechanism by which a business may obtain items from suppliers. Purchase orders facilitate order placement, tracking and fulfillment. The creation and management of purchase orders typically represents a core business function.

Due to its data-intensive nature, the management of purchase orders is conventionally computer-based. Modern Supplier Relationship Management (SRM) systems provide many computerized functions related to the creation, tracking and storage of purchase orders. Several functions, however, have not been adequately addressed to date.

To create a new purchase order using conventional systems, a user opens a blank purchase order and manually completes each field of the blank purchase order (i.e., by typing or selecting from a menu). Some systems allow a user to open a previously-created purchase order, to change data within fields of the previously-created purchase order, and to save the changed purchase order as a new purchase order.

The latter technique may be attractive if the user is able to locate a previously-acquired purchase order including some reusable data elements. However, many other data elements of the previously-created purchase order (e.g., date, delivery date, price, etc.) must typically be changed to create the new purchase order. As a result, the conventional method of creating a new purchase order based on a previously-created purchase order may be no more efficient than creating a new purchase order from a blank purchase order.

Improved systems to create purchase orders are therefore desired.

### BRIEF DESCRIPTION OF THE DRAWINGS

FIG. 1 is a diagram of a network according to some embodiments.

FIG. 2 is a flow diagram of a process according to some embodiments.

FIG. 3 is a view of a user interface according to some embodiments.

FIG. 4 is a view of a user interface according to some embodiments.

FIG. 5 is a view of a user interface according to some embodiments.

FIG. 6 is a view of a user interface according to some embodiments.

FIG. 7 is a view of a user interface according to some embodiments.

FIG. 8 is a view of a user interface according to some embodiments.

FIG. 9 is a view of a user interface according to some embodiments.

FIG. 10 is a flow diagram of a process according to some embodiments.

FIG. 11 is a view of a user interface according to some embodiments.

FIG. 12 is a view of a user interface according to some embodiments.

FIG. 13 is a view of a user interface according to some embodiments.

FIG. 14 is a detailed block diagram of a system according to some embodiments.

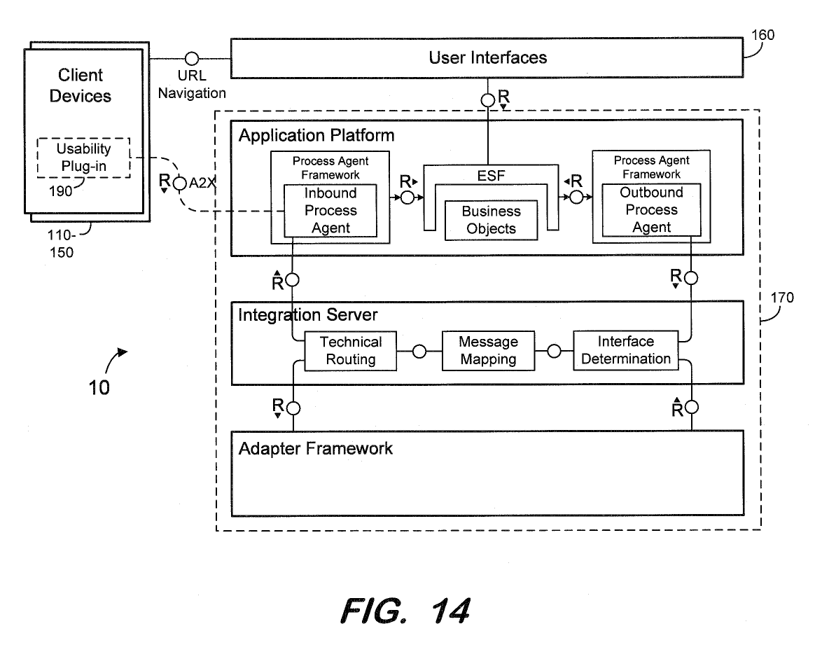

### DETAILED DESCRIPTION

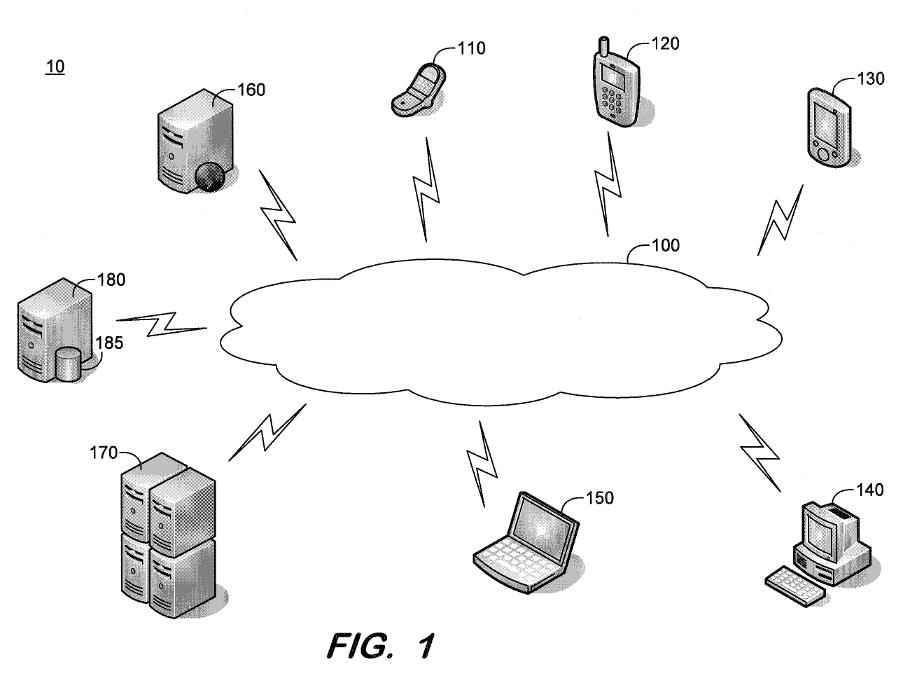

FIG. 1 is a block diagram of system 10 according to some embodiments. Each device of system 10 is capable of communication with network 100, which may comprise the Internet as well as any number of other public and/or private networks. Two or more of devices of system 10 may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

Client devices 110 through 150 may be equipped with any combination of hardware and software to enable communication with Web server 160. According to some embodiments, Web server 160 supports secure HyperText Transfer Protocol (HTTPS) communication with devices 110 through 150. Client devices 110 through 150 may request Web services from Web server 160 to create purchase orders as described below.

Web server 160 may communicate with application servers 170 to provide requested Web services. Application servers 170, in turn, execute business applications (e.g., ABAP or Java) which interface with database management system 180 to access and manipulate business objects stored in relational database 185. Such access and manipulation may result in the creation of a purchase order business object.

Embodiments are not limited to the configuration of system 10. Some embodiments are implemented within a traditional Supplier Resource Management (SRM) system. Such traditional systems may employ a proprietary client application to access business functionality provided by business applications over a secure network. These business applications, as described above, interface with a database management system to access and manipulate business objects stored in a relational database.

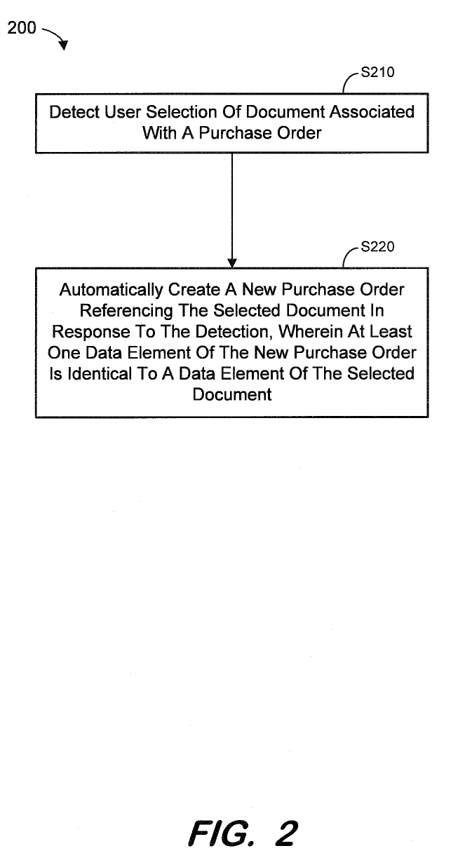

FIG. 2 is a flow diagram of process 200 according to some embodiments. Some embodiments of process 200 may provide efficient creation of a purchase order.

Process 200 and all other processes mentioned herein may be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

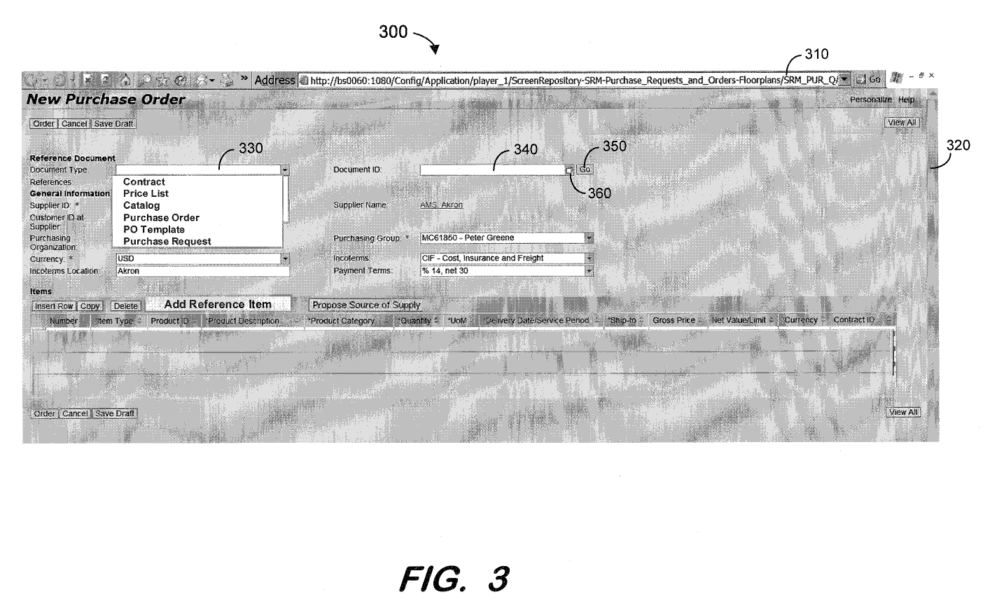

Initially, at S210, user selection of a purchasing-related document is detected. FIG. 3 is a view of interface 300 for receiving the user selection according to some embodiments of S210. User interface 300 may comprise a Web browser window displayed by a client device executing a Web browser.

Address bar 310 includes a Uniform Resource Locator (URL) associated with a desired Web service. More particularly, the client device has requested access to the resource located at the URL. The resource may exist on a private network of which the client device is a member (in which case the client device may communicate via HTTP) or on a public network (HTTPS). After conducting appropriate authentication checks, Web page 320 is delivered to the client device for display in browser window 300.

Web page 320 may comply with any Web formats that are or become known. Web page 320 may comprise a HyperText Markup Language (HTML) page, a Java applet, a Flash control, etc. Embodiments are not, however, limited to Web-based communications.

In order to select a document, a user may first choose from a list of document types displayed by pull-down menu 330. Next, the user may input a document ID of a particular document in field 340. The user then selects Go button 350 to transmit the selected document type and document ID to the Web service provider. Together, the document type and document ID indicate a specific document. Accordingly, reception of the selected document type and document ID results in detection of a user selection of the specific document at S210.

A new purchase order is automatically created at S220 in response to the detection. S220 may comprise instantiation of a business object associated with the new purchase order. The business object may be instantiated using a create_with_reference call which references a business object representing the selected document. At least one data element of the new purchase order is identical to a data element of the selected document.

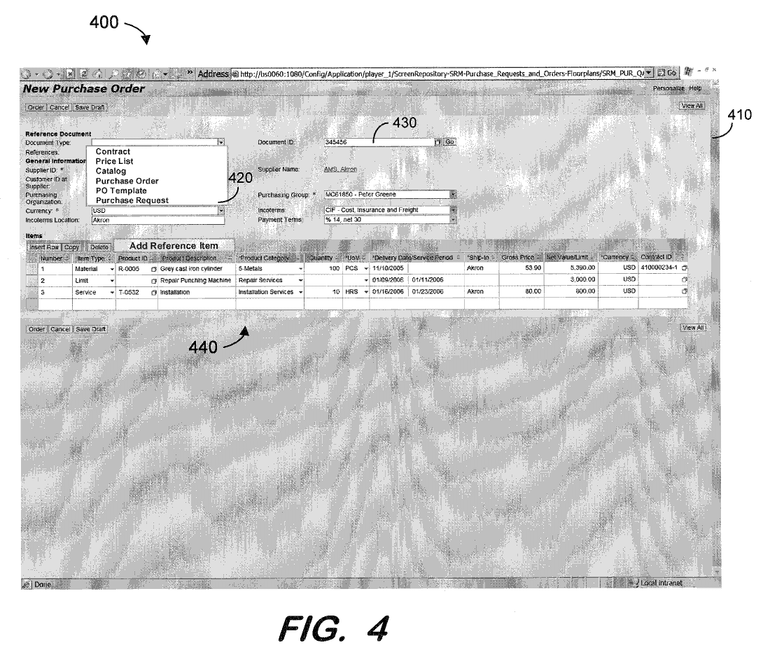

Interface 400 of FIG. 4 illustrates a new purchase order created at S220 according to some embodiments. The user has selected a Purchase Request document type and entered a desired document ID into field 430. In response, a purchase order has been created consisting of three items 440. Each item is associated with a number of individual data fields, hereinafter referred to as data elements.

At least one data element is identical to a data element of the selected purchase request. Any manner of suitable rules may be employed to determine the data elements of the purchase request which are duplicated in the new purchase order at S220. According to some embodiments, each item of the purchase request is duplicated in the new purchase order, but date-related data elements are left empty. Supplier information is also left empty in some embodiments. The newly-created purchase order may also include data elements that are not present in the selected purchase request.

The foregoing example of process 200 relates to a case in which a user knows a document ID of a desired purchase order-related document. In a more likely scenario, a user will know the document type of a desired document but not its document ID. Returning to FIG. 3, this user would select the appropriate document type from menu 330 and then select Search button 360.

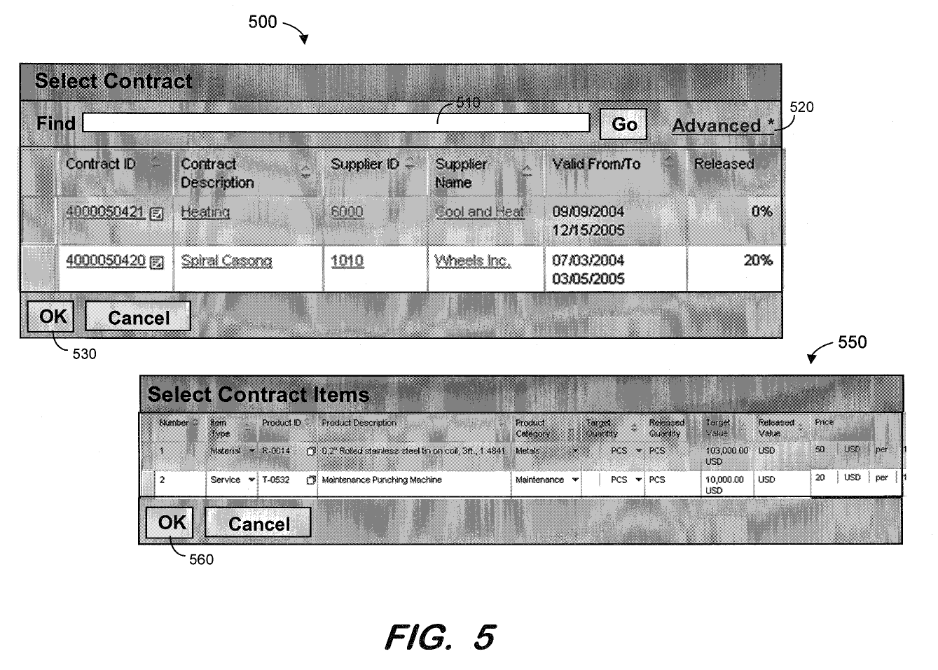

Selection of button 360 may cause interface 500 of FIG. 5 to be displayed as a popup window over interface 300 according to some embodiments. Interface 500 provides search field 510 for inputting search terms. Alternatively, selection of Advanced link 520 causes display of advanced search form 600 for inputting field-specific search terms. Either type of search causes interface 500 to display a list of documents of the selected type and which comply with the input search terms.

One of the listed documents may be selected from interface 500, and the selection is detected at S210 upon selection of OK button 530. A new purchase order may then be automatically created at S220 based on the selected document as described above.

According to some embodiments, selection of OK button 530 causes display of popup window 550 prior to S220. Window 550 illustrates items associated with the selected document. A user may select one or more of the displayed items and OK button 560, after which a new purchase order including the selected items is automatically created at S220.

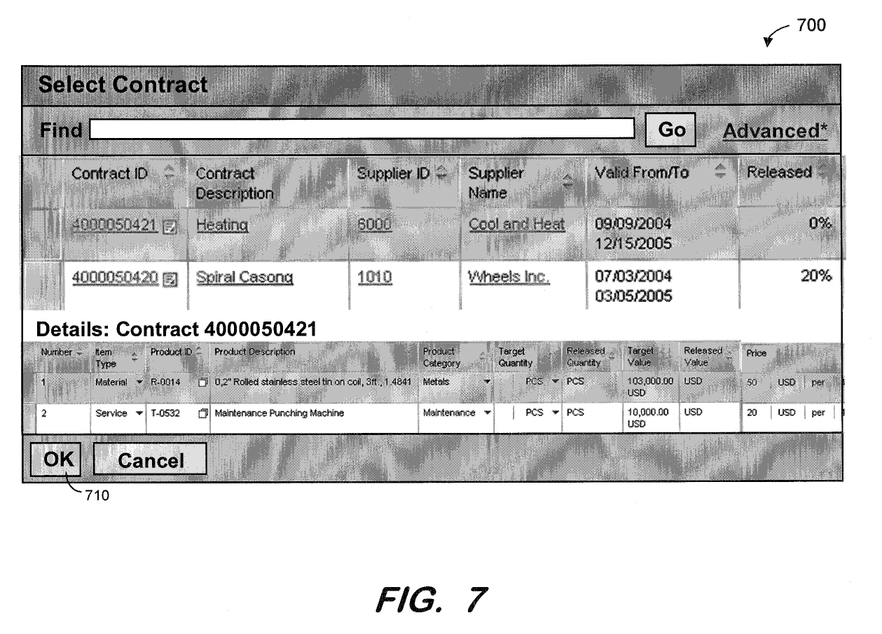

FIG. 7 illustrates interface 700 to select a document according to some embodiments. Interface 700 allows for simple and advanced searching of documents as described above. Also, user interface 700 presents a list of documents resulting from such searches. Upon selection of a listed document, interface 700 presents the data elements of the document. A user may therefore manipulate interface 700 to select either a document or items of a selected document. The selected document and/or items are detected at S210 upon user selection of OK button 710.

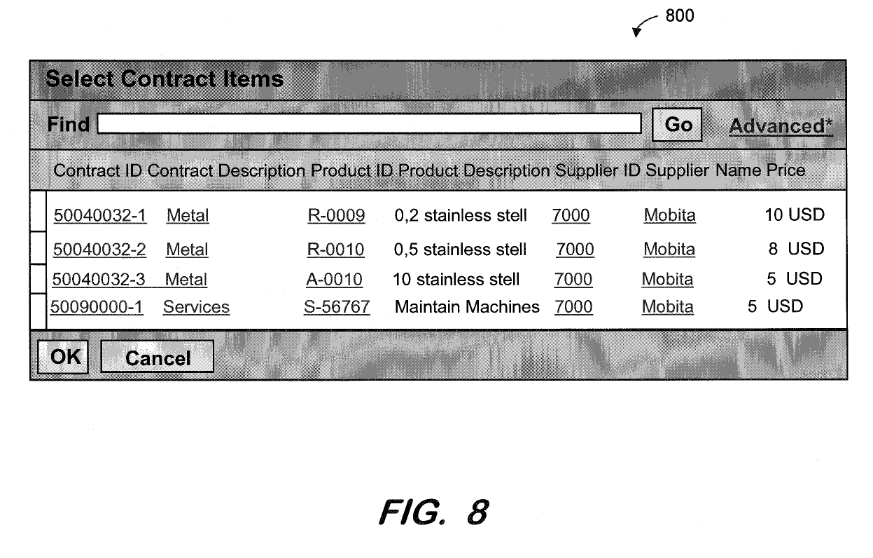

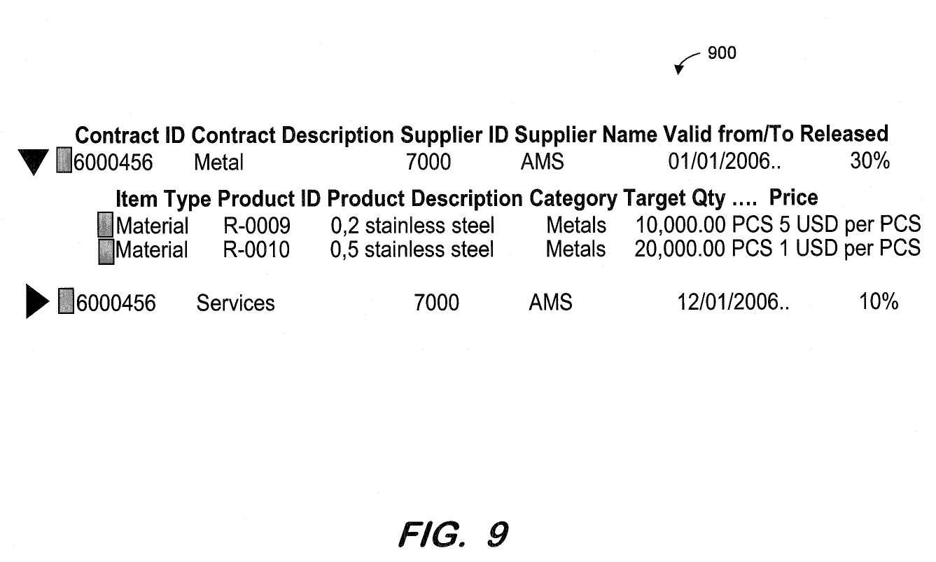

FIGS. 8 and 9 illustrate additional interfaces that may be used to select a document or items to include in a new purchase order. Interface 800 or 900 may be displayed in response to user selection of a document type as described above. Selection of one or more items is detected at S210 as a selection of a corresponding purchasing-related document. Accordingly, interfaces 800 and 900 may be used to determine which data elements of an exiting document are to be included in a newly-created purchase order at S220.

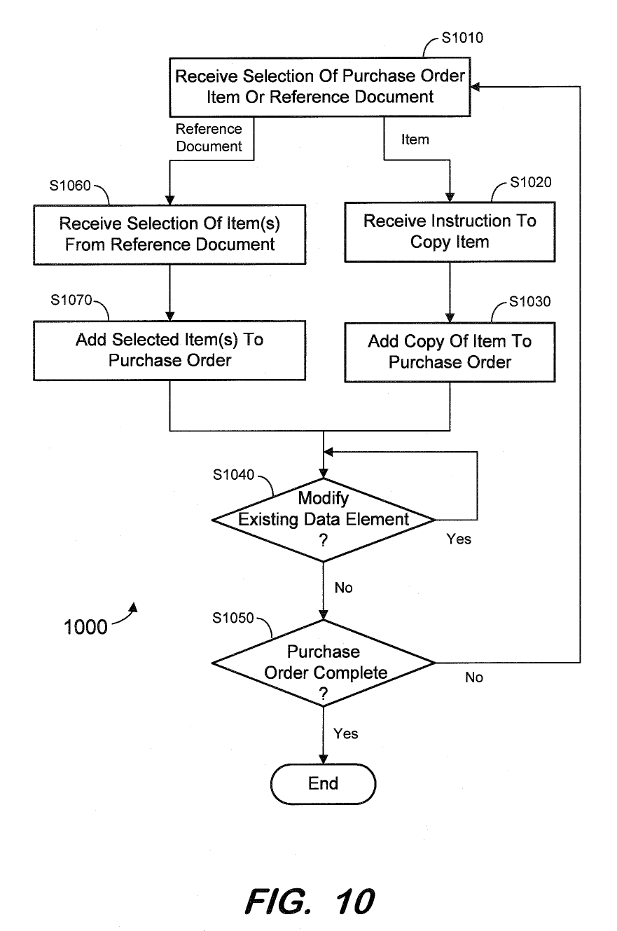

FIG. 10 is a flow diagram of process steps 1000 to edit an existing purchase order according to some embodiments. The existing purchase order may have been created in accordance with process 200, but embodiments are not limited thereto.

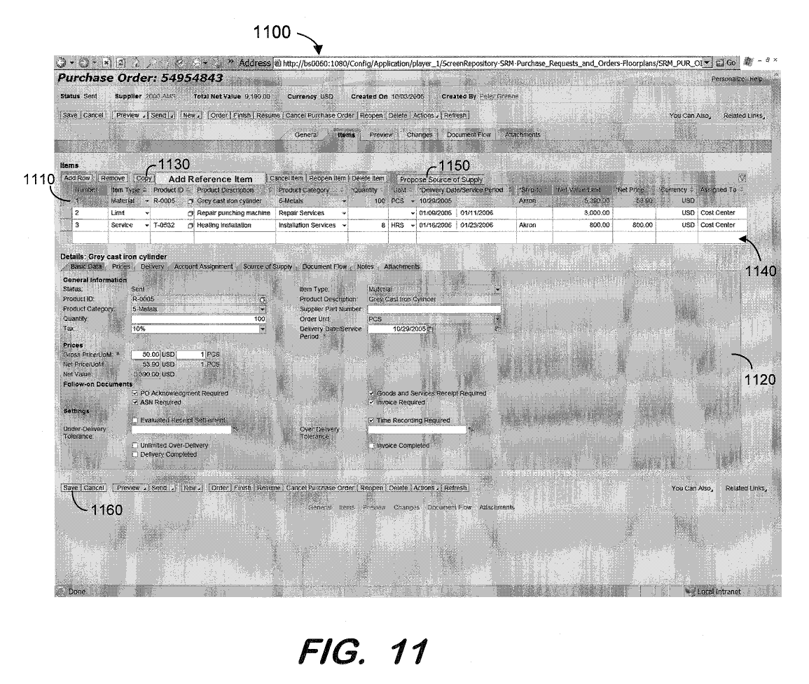

A selection of a purchase order item or a reference document is received at S1010. Initially, it will be assumed that a selection of an item is received at S1010. A user may manipulate interface 1100 of FIG. 11 to select an item of an existing purchase order in some embodiments.

Interface 1100 may again comprise a Web browser window displaying a Web page received from a Web services provider. Interface 1100 presents three items of a purchase order, with item 1110 having been selected. Interface 1100, unlike interface 400 shown above, includes detail area 1120 to present additional details associated with the selected item.

An instruction to copy the selected item is received at S1020. The instruction may be transmitted and received in response to user selection of Copy button 1130 of interface 1100. In response, a business object associated with the purchase order is manipulated to add a copy of the selected item to the purchase order. The copied item may be displayed as an additional item in row 1140 of interface 1100 according to some embodiments.

At S1040, it is determined whether any existing data elements of the purchase order are to be modified. Typically, a user will desire to change at least one data element of an item that was copied at S1030 to avoid including duplicate items in a single purchase order. A user may manipulate fields of detail area 1120 to modify data elements associated with various items.

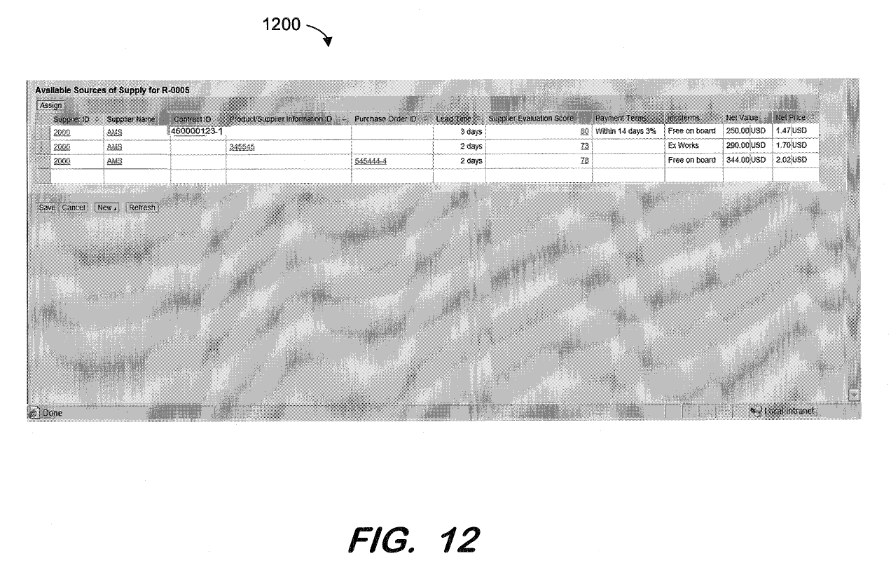

A user may also select Propose Source of Supply button 1150 to modify a data element of an existing item. According to some embodiments, selection of button 1150 results in display of interface 1200 of FIG. 12. Interface 1200 displays sources of supply for the selected item. The displayed information may be retrieved from database 185 by application servers 170 to ensure that the most current information is display. Each record of interface 1200 is associated with a same supplier (AMS) because the selected item was already associated with this supplier, but embodiments are not limited thereto. Even though a same supplier is shown in each record, the various records of interface 1200 may differ in terms of lead time, payment terms, price, etc. Selection of a particular record causes modification of data elements of the associated item.

Flow cycles at S1040 while the user modifies existing data elements as desired, then proceeds to S1050 once all modifications of existing data elements are complete. If the user selects Save button 1160, it is determined that the purchase order is complete and process 1000 terminates. Otherwise, flow returns to S1010 for selection of a purchase order item or a reference document.

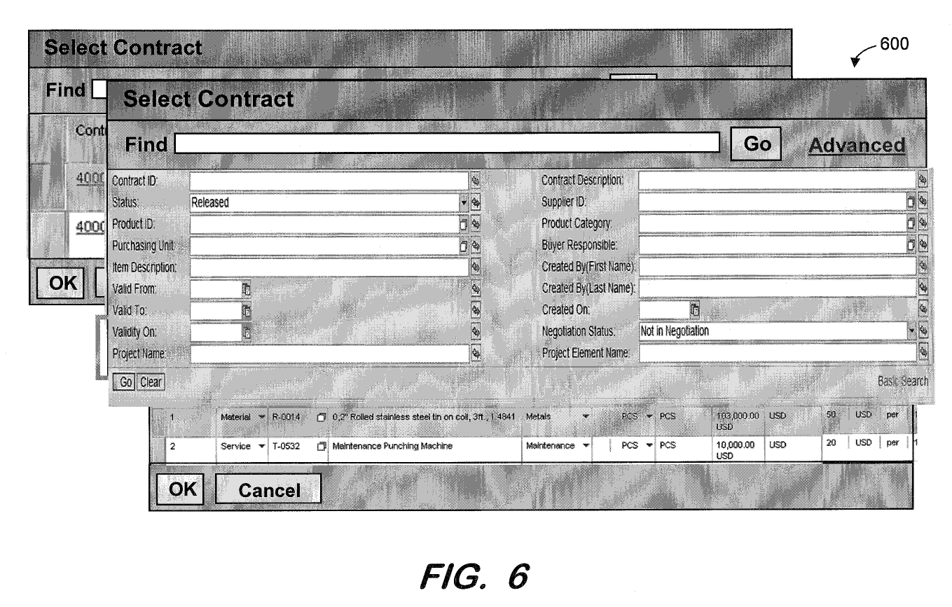

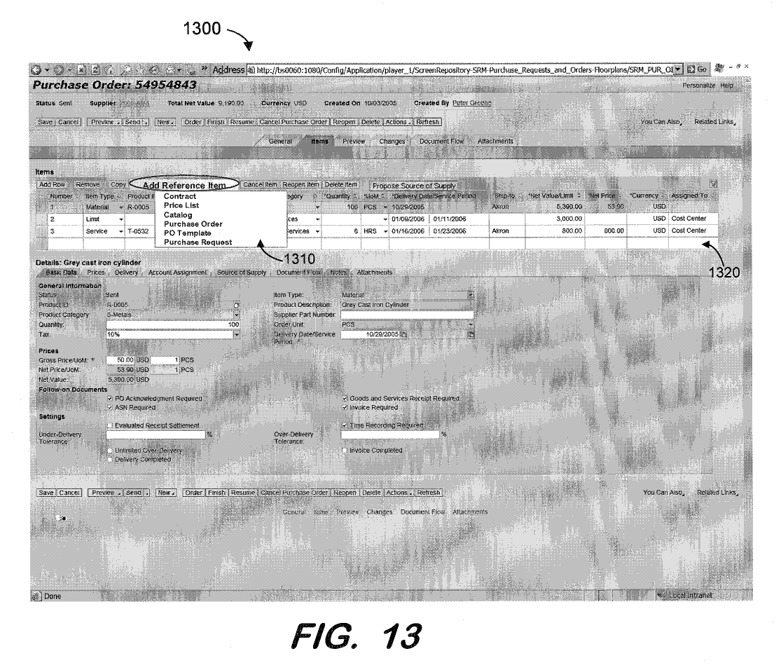

FIG. 13 illustrates selection of a reference document at S1010. A document type may initially be selected from pull-down menu 1310 of window 1300. Any of the methods and interfaces described with respect to FIGS. 5 through 9 may then be used at S1060 to select a particular reference document and specific items of the reference document. These selected items are added to the purchase order at S1070. The thusly-added items may be displayed at row 1320 et seq. of interface 1300. Flow then proceeds from S1070 to S1040 and continues as described above.

FIG. 13 is a detailed block diagram of a portion of system 10 according to some embodiments. Some embodiments may differ from that illustrated in FIG. 13. As mentioned above, some embodiments may comprise a conventional SRM system.

As described above, each of client devices 110 through 150 may support HTTP communication for URL-based navigation to user interfaces provided Web server 160. One or more of device 110 through 150 may also include usability plug-in 190 to provide an extension of base browser functionality. The extension may allow a client device to communicate directly with an application platform of application servers 170.

In this regard, application servers 170 include an application platform, an integration server, and an adapter framework. According to some embodiments, the adapter framework uses adapters to facilitate communication between a business process platform and separate systems associated with each of the adapters. The separate systems may comprise database management systems, legacy data systems, other Enterprise Resource Planning (ERP) systems, or the like.

The integration server routes messages to and from appropriate interfaces of the application platform. The integration server may also provide mapping of incoming and outgoing messages according to pre-configured mappings. SAP XI provides an integration server suitable for use in conjunction with some embodiments.

The application platform supports process agents for implementing message interfaces (i.e., providing Web services) by communicating with an Enterprise Service Framework (ESF), such as a Service-Oriented Architecture (SOA) provided by SAP AG. The ESF provides an API for instantiating and manipulating business objects which encapsulate data and related methods of business logic that describes a business process or task. As described above, purchase orders and purchasing-related documents may be represented by business objects in some embodiments.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

What is claimed is:

1. A method comprising:
detecting user selection of a purchasing-related document; and
in response to the detection, automatically creating a new purchase order based on the selected document,
wherein at least one data element of the new purchase order is identical to a data element of the selected document.

2. A method according to claim 1, wherein automatically creating the new purchase order comprises:
automatically presenting a plurality of data elements of the selected document;
receiving a user selection of one or more of the plurality of data elements; and
automatically creating the new purchase order including the selected one or more of the plurality of data elements.

3. A method according to claim 1, wherein automatically creating the new purchase order comprises:
automatically creating the new purchase order including all items of the selected document.

4. A method according to claim 3, further comprising:
receiving a user indication to delete one of the items from the new purchase order; and
deleting the one of the items from the new purchase order.

5. A method according to claim 1, wherein the document comprises a purchase order, a purchase request, a purchase order template, price list, purchasing contract, or supplier quote.

6. A method according to claim 1,
wherein a supplier and at least one item of the new purchase order is identical to a supplier and at least one item of the selected document.

7. A method according to claim 1, further comprising:
detecting user selection of an item of the new purchase order; and
presenting a current source of supply and a current price associated with the selected item.

8. A method according to claim 7, further comprising:
presenting a second current source of supply and a second current price associated with the selected item.

9. A method according to claim 1, wherein automatically creating the new purchase order comprises:
performing a create_with_reference operation to create an instance of a purchase order referencing an object of the selected document.

10. A computer-readable medium storing processor-executable process steps, the process steps comprising:
a step to detect user selection of a purchasing-related document; and
in response to the detection, a step to automatically create a new purchase order based on the selected document,
wherein at least one data element of the new purchase order is identical to a data element of the selected document.

11. A medium according to claim 10, wherein the step to automatically create the new purchase order comprises:
a step to automatically present a plurality of data elements of the selected document;
a step to receive a user selection of one or more of the plurality of data elements; and
a step to automatically create the new purchase order including the selected one or more of the plurality of data elements.

12. A medium according to claim 10, wherein the step to automatically create the new purchase order comprises:
a step to automatically create the new purchase order including all items of the selected document.

13. A medium according to claim 12, the process steps further comprising:
a step to receive a user indication to delete one of the items from the new purchase order; and
a step to delete the one of the items from the new purchase order.

14. A medium according to claim 10, wherein the document comprises a purchase order, a purchase request, a purchase order template, price list, purchasing contract, or supplier quote.

15. A medium according to claim 10,
wherein a supplier and at least one item of the new purchase order is identical to a supplier and at least one item of the selected document.

16. A medium according to claim 1, the process steps further comprising:
a step to detect user selection of an item of the new purchase order; and
a step to present a current source of supply and a current price associated with the selected item.

17. A medium according to claim 16, the process steps further comprising:
a step to present a second current source of supply and a second current price associated with the selected item.

18. A medium according to claim 1, wherein the step to automatically create the new purchase order comprises:
a step to perform a create_with_reference operation to create an instance of a purchase order referencing an object of the selected document.
